(19) United States
(12) Patent Application Publication
(10) Pub. No.: US 2022/0166299 A1
(43) Pub. Date: May 26, 2022

(54) ADJUSTMENT DRIVE COMPRISING A BRUSH CARD ARRANGEMENT WITH INTEGRATED CIRCUIT BOARD

(71) Applicant: NIDEC Motors & Actuators (Germany) GmbH, Bietigheim-Bissingen (DE)

(72) Inventors: Niklas HERMANN, Bad Wildbad (DE); Max SCHWING, Ludwigsburg (DE)

(21) Appl. No.: 17/421,421

(22) PCT Filed: Jan. 30, 2020
(86) PCT No.: PCT/EP2020/052256

§ 371 Date: Jul. 8, 2021

(30) Foreign Application Priority Data
Feb. 1, 2019 (DE) 10 2019 102 536.2

(51) Int. Cl. H02K 29/08; H02K 11/215

(52) U.S. Cl. CPC H02K 29/08; H02K 2211/03; H02K 11/215

(57) ABSTRACT

An adjustment drive includes a DC brush motor, a brush card assembly including electrical contacts of brushes with busbars, a Hall sensor assembly, and a transmission. The Hall sensor assembly is on a printed circuit board which is integrated in the brush card assembly. A pin terminal is on the printed circuit board to contact the Hall sensor assembly, and the brush card assembly includes a plug body with a plug collar. The plug body is at least partially penetrated by the pin terminal and the busbars to define a plug.

### CROSS REFERENCE TO RELATED APPLICATIONS

This application is a U.S. national stage of PCT Application No. PCT/EP2020/052256, filed on Jan. 30, 2020, and with priority under 35 U.S.C. § 119(a) and 35 U.S.C. § 365(b) being claimed from German Application No. 102019102536.2, filed Feb. 1, 2019; the entire disclosures of which are hereby incorporated herein by reference.

### FIELD OF THE INVENTION

The present invention relates to an adjustment drive.

### BACKGROUND

Multi-pole brushed DC electric motors for motor vehicles use busbars to conduct current between the motor's electrical connector and associated components such as chokes, capacitors and brushes. Conventional busbars must be fabricated and physically attached, supported and connected to the motor. Typically, busbars are riveted to the motor's brush board. Electrical connection is usually achieved by using soldered or thermally bonded joints. Furthermore, a position sensor is provided to detect the angular position of the rotor of the DC motor. This position sensor is preferably a Hall sensor. Conventionally, the Hall sensor is plugged into a wired brush card. This results in new wire cuts being required for each new connector shape. In addition, each type of connector output requires its own accommodation for a motor interference suppression device and a Hall circuit.

### SUMMARY

Example embodiments of the present disclosure provide DC brush motor adjustment drives each including a brush card assembly which is simple and quick to assemble and which is easily adaptable to a connector shape.

An adjustment drive according to an example embodiment of the present disclosure includes a DC brush motor, a brush card assembly to electrically contact the brushes with busbars, a Hall sensor assembly, and a gearbox. The Hall sensor assembly is on a printed circuit board which is integrated in the brush card assembly. A pin terminal is on the printed circuit board to contact the Hall sensor assembly. The brush card assembly includes a plug body with a plug collar, the plug body being at least partially penetrated by the pin terminal and the busbars to define a plug. The brush card assembly defines the brush card of the motor.

The arrangement of the Hall sensor array on a printed circuit board integrated in the brush card array according to example embodiments of the present disclosure leads to significant cost savings both in tool manufacture and in the individual elements, components, and assembly. Furthermore, the subsequent simple housing design has various advantages in the flexible design of the housing tools with regard to the realization of a wide variety of interface designs. The plug body can be easily adapted to a desired or required connector shape. Preferably, the PCB stretches in a plane perpendicular to the motor shaft, which saves even more installation space.

Preferably, the pin terminal is designed with four short and equally long metal sheets. It is advantageous if the metal sheets sit vertically on the surface of the PCB.

Preferably, a longitudinal axis of the plug body is parallel or substantially parallel to a longitudinal axis of the DC motor. The longitudinal axis of the DC motor corresponds to the axis of rotation of the motor. This arrangement is particularly space-saving.

In an advantageous example embodiment, the plug body is adjacent to a motor housing surrounding the DC motor in a radial direction with respect to the longitudinal axis of the DC motor, and a clearance is provided between the plug body and the motor housing.

To save installation space, the plug body is preferably below and in the immediate vicinity of the transmission.

Preferably, the brush card assembly includes a main body which extends around a motor shaft of the DC motor and in which the busbars are guided. It is advantageous if the main body and the plug body of the brush card assembly are provided together in a single monolithic piece.

Preferably, the plug body extends radially outward from the main body and the motor housing.

In one example embodiment of the present disclosure, the Hall sensor assembly preferably includes at least one Hall effect sensor IC in close proximity to the motor shaft and cooperating with a transducer magnet attached to the motor shaft.

It is advantageous if the main body of the brush card assembly is completely covered by the transmission housing.

The printed circuit board is preferably covered by a plug cover in the area of the plug body, the plug cover being fastened to the plug body, in particular clipped on.

It is possible for protective circuits to be located on the printed circuit board in example embodiments of the present disclosure, making the structure very compact.

Advantageously, the printed circuit board is multilayered so that it allows shielding of Hall lines from power lines.

In an advantageous example embodiment, the adjustment drive is a sunroof drive for a motor vehicle.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Similar or similarly acting components are designated in the figures with the same reference signs.

FIG. 1 is a perspective view of a DC brush motor according to an example embodiment of the present disclosure.

FIG. 2 is a spatial representation of a composite brush card assembly according to an example embodiment of the present disclosure.

FIG. 3 is an exploded view of the brush card assembly of FIG. 2.

FIG. 4 is a top view of a plug collar of the brush card assembly of FIG. 2.

### DETAILED DESCRIPTION

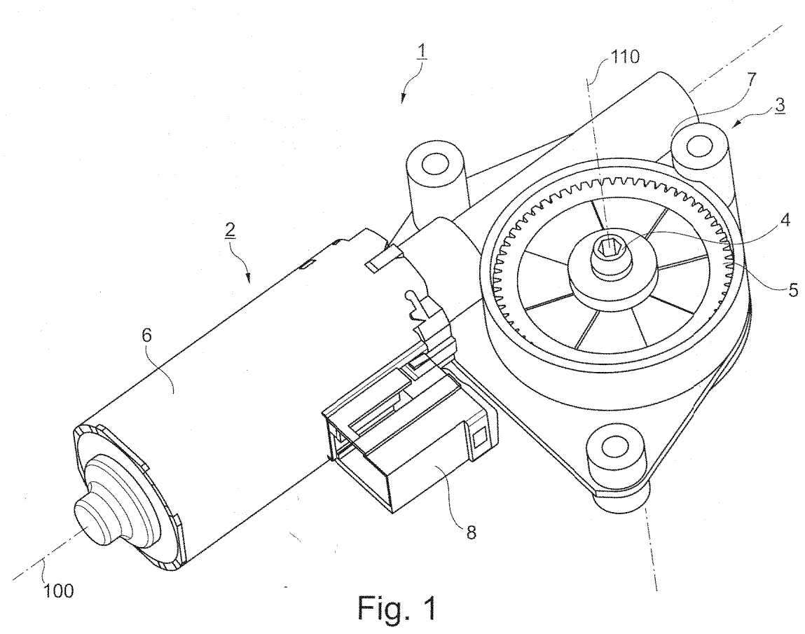

FIG. 1 shows an adjustment drive 1 including a DC brush motor 2 and a transmission 3. In commutator motors, the current is supplied from the power supply or the control device via brushes which are applied to the commutator, which is divided into several laminations and serves to turn the current. The laminations are insulated from one another at the circumference of the commutator and, when the rotor formed by the armature windings, motor shaft and commutator rotates, are supplied with current via the brushes in corresponding succession. A DC voltage, e.g. as a PWM signal, is applied to the brushes by a control device not shown, so that a current is established. The DC motor 2 is designed to drive an output shaft 4. The transmission 3 arranged between the DC motor 2 and the output shaft 4 is preferably a worm gear. The motor shaft is preferably designed as a worm shaft. A corresponding worm gear 5 is seated on the output shaft 4. For the purpose of the geometric description, on the one hand, the axis of rotation of the motor or the longitudinal axis of the motor shaft 100 is assumed to be the central axis and axis of symmetry. Therefore, with respect to the longitudinal axis of the motor shaft, it is referred to a radial direction indicating the distance from the central axis, and a circumferential direction distinguished tangentially to a certain radius arranged in the radial direction. The longitudinal axis of the motor shaft 100 and a longitudinal axis of the output shaft 110 are perpendicular and spaced apart from each other, so that they do not intersect.

The adjustment drive 1 comprises a motor housing 6, in which the DC motor 2 is accommodated, and a gear housing 7, in which the transmission 3 is accommodated.

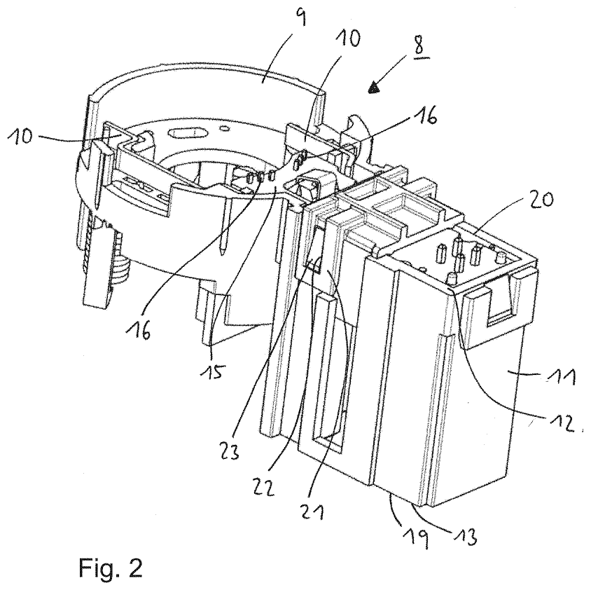

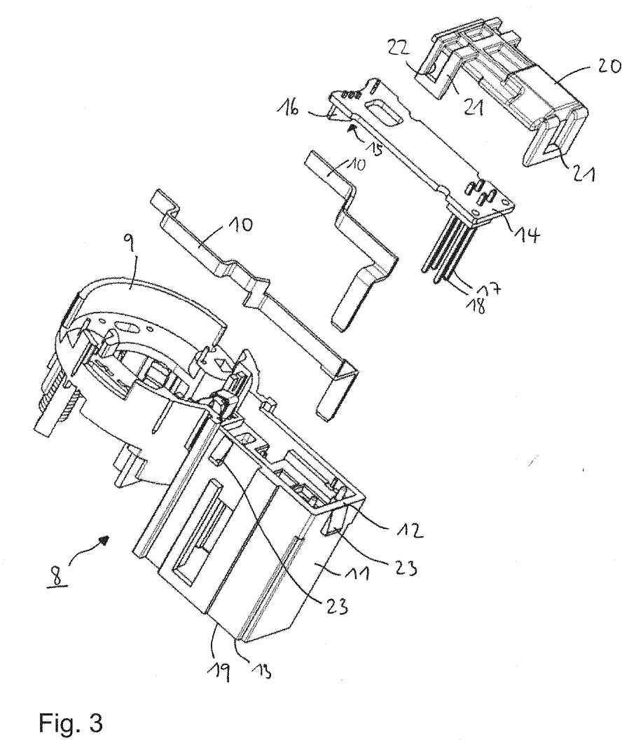

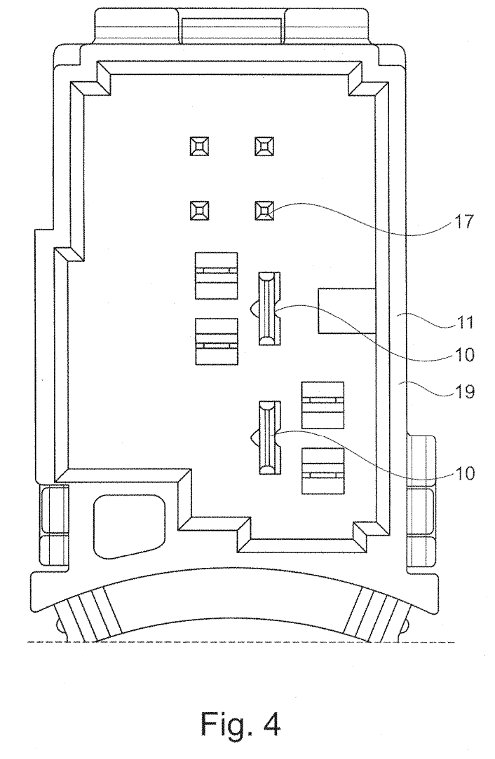

The brushes of the DC motor are electrically contacted via a brush card assembly 8. The brush card assembly 8 is shown in detail in FIGS. 2 to 4.

The brush card assembly 8 has a main body 9 which extends circumferentially around the motor shaft, which is not shown, and on which busbars 10, preferably made of sheet copper, are guided for contacting the brushes at the end surfaces. The main body 9 follows the contour of the motor housing. It is preferably essentially circular-cylindrical in shape and is inserted in the motor housing on the output side. The busbars 10 extend partially along the circumference around the motor shaft and then extend approximately radially outward. Extending from the main body 9 is a plug body 11, which is preferably formed in one piece with the main body 9 and is thus also part of the brush card assembly 8. The plug body 11 is also formed substantially cylindrically with an approximately rectangular base. It extends substantially with its longitudinal axis parallel to the motor shaft. The bus bars 10 are received in the plug body 11 and extend in their end region parallel to the motor shaft to form a plug connection. The plug body 11 has a first end surface 12 close to the gearbox and a second end surface 13 remote from the gearbox. The end surface 12 close to the gearbox is located directly below and thus in the immediate vicinity of the gearbox housing. The plug body 11 is thus arranged below the gear wheel. The end surface 12 near the gearbox is in direct contact with a printed circuit board 14. The printed circuit board 14 is accommodated in the plug body 11. The circuit board 14 extends in a plane perpendicular to the motor shaft. A Hall sensor 15 is disposed on the printed circuit board 14. The printed circuit board 14 is a laminated circuit board with preferably soldered elements applied by surface mounting (SMD) or through hole mounting (THT). On the motor shaft of the electric motor sits a transducer magnet, which interacts with the Hall sensor 15. Preferably, two Hall-effect sensor ICs (integrated circuits) 16 are placed next to each other at a certain distance so that differential evaluation of the sensor signals of the Hall sensor 15 can be made robust against homogeneous interference fields. The at least one Hall-effect sensor IC 16 is thereby located in the main body 9, so that the sensor 15 is in close proximity to the motor shaft within the brush card assembly 8. The printed circuit board 14 also includes electronics for the Hall sensor and a 4-pin terminal 17 for contacting the Hall sensor. The pin terminal 17 extends perpendicularly from the surface or bottom of the circuit board. It is preferably designed with four short and equal-length metal sheets 18 and passes through the plug body 11 parallel to the motor shaft. The plug body 11 forms a plug collar 19 on the side 13 remote from the gearbox, within which the connection pins 17 and the busbars 10 terminate. A connection plug not shown on the customer or vehicle side can be inserted into the plug collar 19 from outside the plug body 11 in the axial direction.

The printed circuit board 14 is covered on a side close to the drive by a plug cover 20. The plug cover 20 covers the part of the printed circuit board 14 that is in contact with the plug body 11. The plug cover 20 is clipped to the plug body 11, for which purpose the plug cover 20 has arms 21 with central recesses 22 and the plug body 11 has projections 23 forming undercuts on the outside. During assembly, the arms 21 of the plug cover 20 snap behind the projections of the plug body 23.

The brush card assembly according to the disclosure has the advantage that the design of the connector can be adapted to customer requirements. By arranging the Hall sensor on the printed circuit board, the leads from the sensor to the connector are replaced. The sensor leads of the Hall sensor are fully integrated in the brush card assembly. The connection on the PCB makes direct contact with the customer connector or vehicle-side connector plug. This significantly simplifies the assembly process, as there is no need to route up to six leads through a narrow connector opening. EMC problems caused by induced AC voltages from sensor lines are also eliminated, since the sensor lines are replaced by the printed circuit board. Protective circuits to compensate or smooth overvoltages or increased AC voltages, such as capacitors, chokes and the like, can be arranged on the PCB.

The plug angle can be changed as required while maintaining the position of the circuit board. Preferably, the connector angle to the surface of the printed circuit board is 90°, i.e. the connector stretches with its longitudinal axis parallel to the motor shaft.

Preferably, a multilayer printed circuit board is used, which allows shielding of Hall lines from power lines.

The adjustment drive is in particular a sliding roof drive of a motor vehicle.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-14. (canceled)

15. An adjustment drive, comprising:
a DC motor;
a brush card assembly including electrical contacts of brushes with busbars;
a Hall sensor assembly; and
a transmission; wherein
the Hall sensor assembly is on a printed circuit board which is integrated in the brush card assembly;
a pin terminal is on the printed circuit board to contact the Hall sensor assembly; and
the brush card assembly includes a plug body with a plug collar, the plug body being at least partially penetrated by the pin terminal and the busbars to define a plug.

16. The adjustment drive of claim 15, wherein a longitudinal axis of the plug body is parallel or substantially parallel to a longitudinal axis of the DC motor.

17. The adjustment drive of claim 15, wherein the plug body is adjacent to a motor housing surrounding the DC motor in a radial direction perpendicular or substantially perpendicular to a longitudinal axis of the DC motor; and
a distance is provided between the plug body and the motor housing.

18. The adjustment drive of claim 15, wherein the plug body is below and adjacent to the transmission.

19. The adjustment drive of claim 15, wherein the brush card assembly includes a main body which extends around a motor shaft of the DC motor and in which the bus bars are guided.

20. The adjustment drive of claim 19, wherein the main body and the plug body of the brush card assembly are defined by a single monolithic structure.

21. The adjustment drive of claim 19, wherein the plug body extends radially outwardly from the main body.

22. The adjustment drive of claim 15, wherein the Hall sensor assembly includes at least one Hall effect sensor IC adjacent to the motor shaft to detect a transducer magnet attached to the motor shaft.

23. The adjustment drive of claim 19, wherein the main body of the brush card assembly is completely covered by the transmission housing on one end surface.

24. The adjustment drive of claim 15, wherein the printed circuit board is covered by a plug cover adjacent to the plug body, the plug cover being fixed to the plug body.

25. The adjustment drive of claim 24, wherein the plug cover is clipped onto the plug body.

26. The adjustment drive of claim 15, further comprising protective circuits are on the printed circuit board.

27. The adjustment drive of claim 15, wherein the printed circuit board is multilayered.

28. The adjustment drive of claim 15, wherein the adjusting drive is a sunroof drive for a motor vehicle.
